(19) United States
(12) Patent Application Publication
(10) Pub. No.: US 2021/0094237 A1
(43) Pub. Date: Apr. 1, 2021

(54) THREE DIMENSIONAL (3D) PRINTING

(71) Applicant: HEWLETT-PACKARD DEVELOPMENT COMPANY, L.P., Spring, TX (US)

(72) Inventors: Timothy L Weber, Corvallis, OR (US); Andrew L Van Brocklin, Corvallis, OR (US); James E Clark, Corvallis, OR (US); Jason C Hower, Corvallis, OR (US)

(21) Appl. No.: 16/608,259

(22) PCT Filed: Apr. 4, 2018
(86) PCT No.: PCT/US2018/025972

§ 371 Date: Oct. 25, 2019

(51) Int. Cl. B29C 64/393; B33Y 50/02; B29C 64/112; B33Y 30/00; B29C 64/209; B33Y 10/00

(52) U.S. Cl. CPC B29C 64/393; B33Y 50/02; B33Y 10/00; B33Y 30/00; B29C 64/209; B29C 64/112

(57) ABSTRACT

In an example implementation, a method of 3D printing includes receiving a 2D data slice derived from a 3D object model, where the 2D data slice defines an object area of a layer of build material that is to receive a liquid functional agent and be fused as a layer of a part. The method includes determining that the 2D data slice distinguishes first and second tolerance zones within the object area. The method includes controlling a printhead to print a liquid functional agent onto the layer of build material according to a first droplet ejection spacing when printing in the first tolerance zone, and controlling the printhead to print a liquid functional agent onto the layer of build material according to a second droplet ejection spacing when printing in the second tolerance zone.

### BACKGROUND

Additive manufacturing processes can produce three-dimensional (3D) objects by providing a layer-by-layer accumulation and solidification of build material patterned from digital 3D object models. In some examples, inkjet printheads can selectively print (i.e., deposit) liquid functional agents such as fusing agents or binder liquids onto layers of build material within patterned areas of each layer. The liquid agents can facilitate the solidification of the build material within the printed areas. For example, fusing energy can be applied to a layer to thermally fuse together build material in areas where fusing agent has been applied. The solidification of selected regions of build material can form 2D cross-sectional layers of the 3D object being produced, or printed.

### BRIEF DESCRIPTION OF THE DRAWINGS

Examples will now be described with reference to the accompanying drawings, in which:

FIG. 1a shows a block diagram of an example of a 3D printing system suitable for providing variable sub-voxel printing;

FIGS. 1b and 1c show alternate examples of a controller of a 3D printing system that include additional or alternate modules;

FIG. 2 shows examples of representative alterations that can be made to sizes of voxels of a 3D object model;

FIGS. 3a, 3b, and 3c show example representations of how example object voxels can be printed in accordance with voxels of a 3D object model whose sizes have been altered within different tolerance zones;

FIGS. 4, 5, and 6, show an example 3D part that has a number of different tolerance zones throughout the part; and,

FIGS. 7a, 7b, and 8, are flow diagrams showing example methods of 3D printing.

Throughout the drawings, identical reference numbers designate similar, but not necessarily identical, elements.

### DETAILED DESCRIPTION

In some additive manufacturing processes, such as some 3D printing processes, for example, 3D objects or parts can be formed on a layer-by-layer basis where each layer is processed and portions thereof are combined with a subsequent layer until the 3D object is fully formed. Throughout this description, the terms ‘part’ and ‘object’ and their variants may be used interchangeably. In addition, while a particular powder-based and fusing agent 3D printing process is used throughout this description as one example of a suitable additive manufacturing process, concepts presented throughout this description may be similarly applicable to other processes such as binder jetting, laser metal deposition, and other powder bed-based processes. Furthermore, while build material is generally referred to herein as being powdered build material, such as powdered nylon, there is no intent to limit the form or type of build material that may be used when producing a 3D object from a 3D digital object model. Various forms and types of build materials may be appropriate and are contemplated herein. Examples of different forms and types of build materials can include, but are not limited to, short fibers that have been cut into short lengths or otherwise formed from long strands or threads of material, and various powder and powder-like materials including plastics, ceramics, metals, and the like.

In various 3D printing processes and other additive manufacturing processes, layers of a 3D object can be produced from 2D slices of a digital 3D object model, where each 2D slice defines portions of a powder layer that are to form a layer of the 3D object. Information in a 3D object model, such as geometric information that describes the shape of the 3D model, can be stored as plain text or binary data in various 3D file formats, such as STL, VRML, OBJ, FBX, COLLADA, 3MF, and so on. Some 3D file formats can store additional information about 3D object models, such as information indicating colors, textures and/or surface finishes, material types, and mechanical properties and tolerances.

The information in a 3D object model can define solid portions of a 3D object to be printed or produced. To produce a 3D object from a 3D object model, the 3D model information can be processed to provide 2D planes or slices of the 3D model. In different examples, 3D printers can receive and process 3D object models into 2D slices, or they can receive 2D slices that have already been processed from 3D object models. Each 2D slice generally comprises an image and/or data that can define an area or areas of a layer of build material (e.g., powder) as being solid part areas where the powder is to be solidified during a 3D printing process. Thus, a 2D slice of a 3D object model can define areas of a powder layer that are to receive (i.e., be printed with) a liquid functional agent such as a fusing agent or a binding agent. Conversely, areas of a powder layer that are not defined as part areas by a 2D slice, comprise non-part areas where the powder is not to be solidified. Non-part areas may receive no liquid functional agent, or they may receive a detailing agent that can be selectively applied around part contours, for example, to cool the surrounding build material and keep it from fusing.

In some example powder-based and fusing agent 3D printing systems, layers of powdered build material can be spread over a platform or print bed within a build area. As noted above, a liquid functional agent (i.e., a fusing agent) can be selectively applied to each powder layer in areas where the particles of powdered material are to be fused together or solidified to form a part as defined by each 2D slice of a 3D object model. Each layer in the build area can be exposed to a fusing energy to thermally fuse together and solidify the particles of powdered material where the fusing agent has been applied. This process can be repeated, one layer at a time, until a 3D part or 3D parts have been formed within the build area.

Methods for applying a liquid functional agent onto selective areas of a layer of powdered build material can include the use of inkjet printheads to accurately deposit (i.e., print) a droplet of the liquid agent into a small volume of powder. Each small volume of powder can be digitally represented within a 3D object model by a discrete volume element representation, referred to as a “voxel”. For each voxel within a digital 3D object model, a corresponding volume of powder on the print bed of a build area can be printed with a liquid agent and subsequently fused to form a portion of a 3D object. Thus, these corresponding volumes of powder on the print bed, whether they have been printed or are still to-be-printed, can be considered to be discrete volumes of powder that exist temporarily prior to being fused together or otherwise solidified into a 3D object. Accordingly, for purposes of this description, such volumes of powder on the print bed can be referred to herein as “object voxels”. Thus, an object voxel can be considered to be the manifestation in the physical domain, of a corresponding voxel from the digital domain of a 3D object model.

In general, increasing the resolution of a 3D object can be achieved by forming the object from a greater number of smaller sized printed powder volumes (i.e., the object voxels). The 3D objects produced from smaller object voxels can have a higher resolution (i.e., finer resolution) than 3D objects produced from larger object voxels. Higher resolution 3D objects can enable tighter mechanical tolerances, finer surface finishes, greater strength, and generally improved part quality. Furthermore, generating higher quality parts in a 3D printing process can help to reduce the amount of post-processing involved in preparing the parts for delivery and use. Post-processing operations can include, for example, cleaning, sanding, machining, filling, priming, painting, and so on. Post-processing operations are generally considered to be non-value-added operations that increase overall costs and lengthen part delivery times.

A number of methods have been used to increase the resolution of 3D objects during printing. In general, the resolution of a 3D printed object can be affected by the native resolution of the printhead, as determined by the printhead nozzle pitch or nozzles per inch on the printhead. For example, some printheads can deposit droplets at a resolution of 1/1200 of an inch (21 μm), based on the printhead nozzle pitch. In addition to the native printhead resolution, other factors can influence the resolution of a printed part. For example, the part resolution can be increased by taking multiple passes of the printheads over each layer of build material. Another example includes using printheads with different nozzles capable of ejecting varying liquid drop sizes. Smaller drop sizes can create smaller printed powder volumes (i.e., smaller object voxels) and thereby increase part resolution.

While some prior methods such as those noted above can help to increase 3D part resolution, they can also significantly increase both the time and cost of printing 3D parts. For example, the time to print a 3D part can more than double when printheads are passed multiple times over each layer of powder to print liquid agent droplets.

Accordingly, example methods and systems described herein provide for variable “sub-voxel printing” that enables variable resolution within 3D parts. In sub-voxel printing, some 3D printing systems can apply altered voxel sizes in a universal manner across all the 3D object models within a 3D object build. Altering a voxel size can alter the relative lengths of the voxel along the x-axis, y-axis, and z-axis of the 3D printing system. For example, the length of a voxel along the x-axis of the system can be shortened relative to the length of the voxel along the y-axis or z-axis. Such shortening along the x-axis reduces the voxel size along the x-axis, and enables control of the 3D printing system to print into a smaller printed object voxel (i.e., smaller printed powder volume) whose size is reduced along the x-axis in a corresponding manner.

Altering voxel sizes can reduce (or increase) voxel sizes in one or multiple axes of voxels in a 3D object model, which enables control in some example 3D printing systems to print into object voxels (printed powder volumes) whose sizes are correspondingly reduced (or increased) on the print bed. Thus, in some examples, sub-voxel printing is possible along all three axes of a 3D printing system, or on a single axis per voxel, or on multiple axes per voxel. In other examples, however, sub-voxel printing can be limited by 3D print system machine designs, throughput limitations, and machine cost constraints. Thus, in some example systems, implementing sub-voxel printing in a 3D printing system can include moving a printhead along the x-axis and/or the y-axis of the print system, and/or moving the print bed along the z-axis of the print system, through smaller distances in between each droplet ejection in order to print into reduced-sized object voxels. Smaller distances between droplet ejections can be achieved, for example, by slowing down the speed of printhead and/or increasing the droplet ejection frequency.

Creating higher resolution parts by applying sub-voxel printing universally across all the 3D object models within a 3D object build can significantly increase the time and costs associated with generating 3D parts. Thus, a variable application of sub-voxel printing as described herein through example methods and systems enables the generation of 3D parts with varying part resolutions while also maintaining the throughput of 3D printing systems. Voxel sizes along one or multiple of the x, y, and z axes of a 3D printing system can be adjusted in order to vary the printed resolution within different areas or zones of a single 3D part. For example, during printing of a 3D part, voxel sizes can be reduced in particular zones of the 3D object model where tighter mechanical tolerances and smoother surface finishes have been specified. The reduced voxel sizes cause a 3D printing system to print into smaller corresponding object voxels (powder volumes) on the print bed, effectively increasing the number of object voxels to be fused together to form the part, thereby increasing the part resolution within the tighter tolerance zones.

In areas of a 3D object model where looser mechanical tolerances have been specified, voxel sizes can be increased. The larger voxel sizes cause a 3D printing system to print larger corresponding object voxels on the print bed, effectively decreasing the number of object voxels to be fused together to form the part, thereby decreasing the part resolution within the looser tolerance zones. Thus, the variable application of sub-voxel printing within a 3D part helps to optimize print speed when printing zones within a part that specify relaxed mechanical tolerances and non-critical (e.g., non-smooth) surfaces, while also providing increased resolution and higher precision in part zones that specify tighter mechanical tolerances and/or critical (e.g., smooth) surfaces. Such variations in 3D part resolution can be applied along one or multiple of the x, y, and z axes of a 3D printing system, for example, by adjusting the distance (and hence speed) of the printhead movement in the x and/or y axes between droplet ejections, and/or adjusting the thickness of the powder layers deposited in the z axis. In some examples where the printhead comprises a scanning type printhead, as discussed further below, adjusting the distance between droplet ejections can be achieved, for example, by changing the speed of printhead movement across the powder layer and/or by adjusting the frequency of droplet ejection in the x and/or y axes. In some examples where the printhead comprises a page-wide type printhead, as discussed further below, adjusting the distance between droplet ejections can be achieved, for example, by changing the speed of printhead movement across the powder layer and/or by adjusting the frequency of droplet ejection in the x axis. The distance between droplet ejections in the y axis is generally fixed but in some examples can be adjusted through shifting the printhead in the y axis direction between multiple printhead passes.

In a particular example, a method of 3D printing includes receiving a 2D data slice derived from a 3D object model, where the 2D data slice defines an object area of a layer of build material that is to receive a liquid functional agent and be fused as a layer of a part. The method includes determining that the 2D data slice distinguishes first and second tolerance zones within the object area. The method includes controlling a printhead to print a liquid functional agent onto the layer of build material according to a first droplet ejection spacing when printing in the first tolerance zone, and controlling the printhead to print a liquid functional agent onto the layer of build material according to a second droplet ejection spacing when printing in the second tolerance zone.

In another example, a 3D printing system includes a memory to receive a 3D object model that represents a 3D part to be printed. The system includes a processor programmed with 2D slice generator instructions to generate 2D data slices from the 3D object model, where each 2D data slice is to define an object area of a build material layer and to distinguish different tolerance zones within the object area. The system includes a printhead to eject liquid droplets onto a build material layer according to a first droplet spacing when printing in a first tolerance zone, and to eject liquid droplets onto the build material layer according to a second droplet spacing when printing in a second tolerance zone.

In another example, a method of 3D printing includes receiving a 3D object model defining a part to be printed, and analyzing the 3D object model to generate tolerance data based on features within the 3D object model. The method also includes processing the 3D object model according to the tolerance data to generate 2D data slices that each define first and second tolerance zones within an object area on a layer of the part, and controlling a printhead to print a liquid droplets on the layer at a first spacing when printing in the first tolerance zone, and at a second spacing when printing in the second tolerance zone.

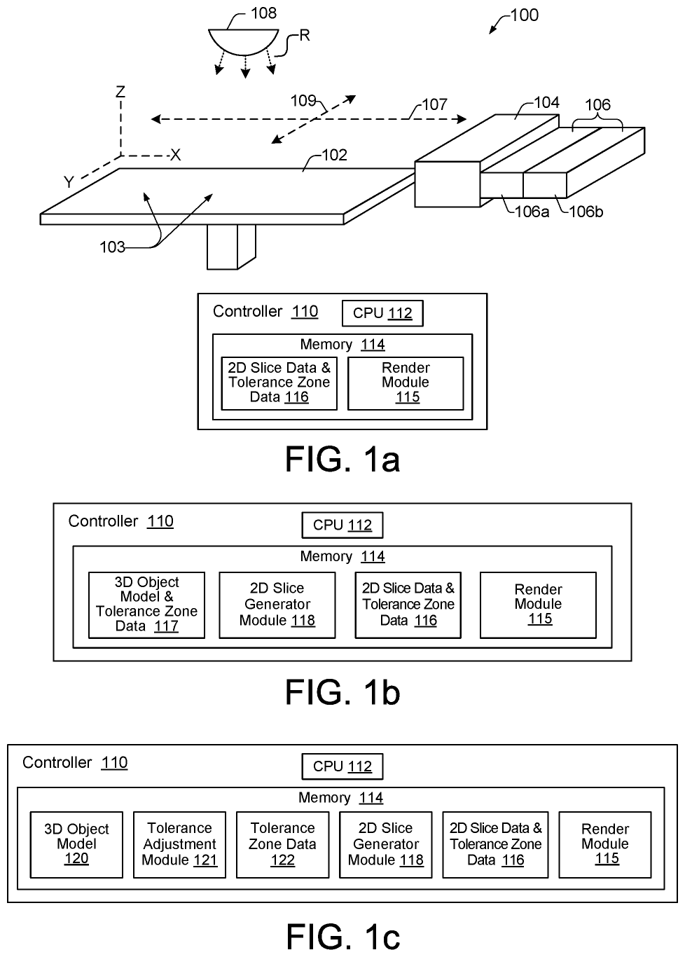

FIG. 1a shows a block diagram of an example of a 3D printing system 100 suitable for providing variable “sub-voxel printing” that enables variable resolution within 3D parts. The 3D printing system 100 is shown by way of example only and is not intended to represent a complete 3D printing system. Thus, it is understood that an example system 100 may comprise additional components and may perform additional functions not specifically illustrated or discussed herein.

An example 3D printing system 100 includes a moveable print bed 102, or build platform 102 to serve as the floor to a work space or build area 103 in which 3D objects can be printed. In some examples the print bed 102 can move in a vertical direction (i.e., up and down) in the z-axis direction. The build area 103 generally comprises a build volume that develops over the print bed 102 as the print bed moves downward during the layer-by-layer printing and solidification of a 3D part. A powdered build material distributor 104 can provide a layer of powder over the print bed 102. In some examples, a suitable powdered build material can include PA12 build material commercially known as V1R10A “HP PA12” available from HP Inc. The powder distributor 104 can include a powder supply and powder spreading mechanism such as a roller or blade to move across the print bed 102 in the x-axis direction to spread a layer of powder. In some examples, as discussed herein below, movement of the print bed 102 in the z-axis can be controlled to implement sub-voxel printing in which the thickness of a layer of powder is altered (e.g., reduced) to generate object voxels whose z-axis size follows or scales with the altered z-axis size of corresponding voxels within a 3D object model of a part being printed. Such controlled movement of the print bed 102 can be used to vary the resolution of a 3D part along the z-axis.

A liquid agent dispenser 106 can deliver a liquid functional agent such as a fusing agent and/or detailing agent from a fusing agent dispenser 106a and detailing agent dispenser 106b, respectively, in a selective manner onto areas of a powder layer provided on the print bed 102. In some examples a suitable fusing agent can include an ink-type formulation comprising carbon black, such as the fusing agent formulation commercially known as V1Q60Q “HP fusing agent” available from HP Inc. In different examples, fusing agent formulations can also comprise an infra-red light absorber, a near infra-red light absorber, a visible light absorber, and a UV light absorber. Inks comprising visible light enhancers can include dye based colored ink and pigment based colored ink, such as inks commercially known as CE039A and CE042A available from HP Inc. An example of a suitable detailing agent can include a formulation commercially known as V1Q61A “HP detailing agent” available from HP Inc. Liquid agent dispensers 106 can include, for example, a printhead or printheads, such as thermal inkjet or piezoelectric inkjet printheads. In some examples, a printhead dispenser 106 can comprise a page-wide array of liquid ejectors (i.e., nozzles) that spans across the full y-axis dimension of the print bed 102 and moves bi-directionally (i.e., back and forth) in the x-axis as indicated by direction arrow 107 while it ejects liquid droplets onto a powder layer spread over the print bed 102. In other examples, a printhead dispenser 106 can comprise a scanning type printhead. A scanning type printhead can span across a limited portion or swath of the print bed 102 in the y-axis dimension as it moves bi-directionally in the x-axis as indicated by direction arrow 107, while ejecting liquid droplets onto a powder layer spread over the print bed 102. Upon completing each swath, a scanning type printhead can move in the y-axis direction as indicated by direction arrow 109 in preparation for printing another swath of the powder layer on print bed 102. In some examples, as discussed herein below, the ejection frequency and/or the speed of movement of a printhead 106 in the x-axis and/or y-axis, can be controlled to implement sub-voxel printing in which the distance or spacing between liquid droplet ejections is altered (e.g., reduced). Altering the droplet ejection spacing in this manner can generate object voxels on the print bed 102 whose x-axis and/or y-axis size follows, or scales with, altered x-axis and/or y-axis sizes of corresponding voxels within a 3D object model of a part being printed. Such control of the movement and/or ejection frequency of a printhead 106 can be used to vary the resolution of a part along the x-axis and/or y-axis.

The example 3D printing system 100 also includes a fusing energy source 108, such as radiation source 108, that can apply radiation R to powder layers on the print bed 102 to facilitate the heating and fusing of the powder. In some examples, the energy source 108 can comprise a scanning energy source that scans across the print bed 102 in the x-axis direction. In some examples, where a 3D printing system comprises a binder jetting system that can print a liquid binder agent onto different materials such as metals, ceramics, and plastics, for example, the system 100 can include a binder agent drying/curing unit (not shown).

Referring still to FIG. 1a, an example 3D printing system 100 additionally includes an example controller 110. FIGS. 1b and 1c show further examples of a controller 110 that includes additional or alternate modules. Referring to FIGS. 1a, 1b, and 1c, the controller 110 can control various operations of the 3D printing system 100 to facilitate the printing of 3D objects as generally described herein, such as controllably spreading powder onto the print bed 102, selectively applying fusing agent and detailing agent to portions of the powder, and exposing the powder to radiation R. In addition, the controller 110 can further control operations of the 3D printing system 100 to implement variable sub-voxel printing as described herein to generate variable resolution 3D parts.

Referring to FIGS. 1a, 1b, and 1c, an example controller 110 can include a processor (CPU) 112 and a memory 114. The controller 110 may additionally include other electronics (not shown) for communicating with and controlling various components of the 3D printing system 100. Such other electronics can include, for example, discrete electronic components and/or an ASIC (application specific integrated circuit). Memory 114 can include both volatile (i.e., RAM) and nonvolatile memory components (e.g., ROM, hard disk, optical disc, CD-ROM, flash memory, etc.). The components of memory 114 comprise non-transitory, machine-readable (e.g., computer/processor-readable) media that can provide for the storage of machine-readable coded program instructions, data structures, program instruction modules, JDF (job definition format), plain text or binary data in various 3D file formats such as STL, VRML, OBJ, FBX, COLLADA, 3MF, and other data and/or instructions executable by a processor 112 of the 3D printing system 100.

As shown in the example controller 110 of FIG. 1a, an example of executable instructions to be stored in memory 114 include instructions associated with render module 115, while an example of stored data includes 2D slice data and tolerance zone data 116. Thus, a 3D printing system 100 can receive 3D part data that has been pre-processed (e.g., from a 3D object model) into the form of 2D slice data with tolerance zone data 116. In some examples, an external system, such as a CAD system (not shown), can enable a user to embed varying tolerance zone information into a 3D object model. The 3D object model with the embedded tolerance zone information can then be processed on the external system (or some other external system) to generate 2D slices of the 3D object model, where each 2D slice can define different tolerance zones or part areas within each part layer that have different resolutions. In general, when rendered, the 2D slices can inform the 3D printing system which zones to process with higher part resolution. For example, the 2D slice data can include a tolerance zone comprising a greater number of smaller voxels for the 3D printing system to process, as well as a tolerance zone comprising a lesser number of larger voxels for the 3D printing system to process. Furthermore, the 2D slice data can include tolerance zone information that specifies different powder layer thickness levels in order to process higher part resolution in the z-axis of the 3D printing system. The 2D slice data can be received by the 3D printing system 100 as the 2D slice data and tolerance zone data 116 shown in FIG. 1a. The 2D slice data and tolerance zone data 116 can be rendered by the printer controller 110 (e.g., executing instructions from a render module 115), to generate 3D printer system commands that can control components of the 3D printing system 100 to print each layer of a part according to the 2D slice data and tolerance zone data 116. In another example controller 110 as shown in FIG. 1b, a 3D printing system 100 can receive a 3D object model and tolerance zone data 117 that represents a part to be printed. In some examples, an external system such as a CAD system (not shown), can enable a user to embed varying tolerance zone information into a 3D object model. The embedded 3D object model can be received by the 3D printing system 100 as the 3D object model and tolerance zone data 117. The 3D object model and tolerance zone data 117 can be processed by the controller 110 executing instructions from a 2D slice generator module 118 (FIG. 1b), for example, to generate 2D slice data and tolerance zone data 116. As discussed above regarding FIG. 1a, the 2D slice data and tolerance zone data 116 can be rendered by the printer controller 110 executing instructions from a render module 115, for example, to generate 3D printer system commands that can control components of the 3D printing system 100 to print each layer of a part according to the 2D slice data and tolerance zone data 116. In another example controller 110 as shown in FIG. 1c, a 3D printing system 100 can receive a 3D object model 120 that represents a part to be printed. The controller 110, executing instructions from a tolerance adjustment module 121, for example, can determine tolerance zone data 122 in different ways. In one example, the tolerance adjustment module 121 can execute to cause the controller 110 to analyze the 3D object model 120 to determine or identify areas and/or features of the 3D object model 120 as critical tolerance areas to be printed with a higher resolution. Examples of such areas and/or features that may be identified as critical tolerance areas to be printed with a higher resolution might include features below a minimum size measure or above a maximum contour variation measure, such as small posts or other protrusions on a part that tend to be more fragile, part interface features such as gear teeth with significant contour variation where the part may interface with other parts, and so on. To identify such features, the controller 110 may execute instructions from tolerance adjustment module 121, for example, to compute distances between features of the 3D object model and then apply a minimum feature size threshold to the computed distances. In another example, the tolerance adjustment module 121 can execute to determine tolerance zone data 122 by enabling a user to input tolerance zone information. The tolerance adjustment module 121 can analyze the 3D object model 120 and provide a representation of the model to a user (e.g., via a user interface), enabling the user to identify specific zones or areas of the 3D object model 120 as critical tolerance areas to be printed with a higher resolution. Thus, in one example, tolerance zone data 122 can be determined by the 3D printing system 100, and in another example the tolerance zone data 122 can be received as user input data. The controller 110 can then execute instructions from the 2D slice generator module 118 (FIG. 1c) to generate 2D slice data and tolerance zone data 116 based on the 3D object model 120 and the tolerance zone data 122. The 2D slice data and tolerance zone data 116 can then be rendered by the printer controller 110 executing instructions from a render module 115 to generate 3D printer system commands that can control components of the 3D printing system 100 to print each layer of a part according to the 2D slice data and tolerance zone data 116. In general, therefore, in different examples, the 3D printing system 100 can print a 3D object based on 3D object model information and tolerance zone information that has been received in different forms and with different degrees of pre-processing.

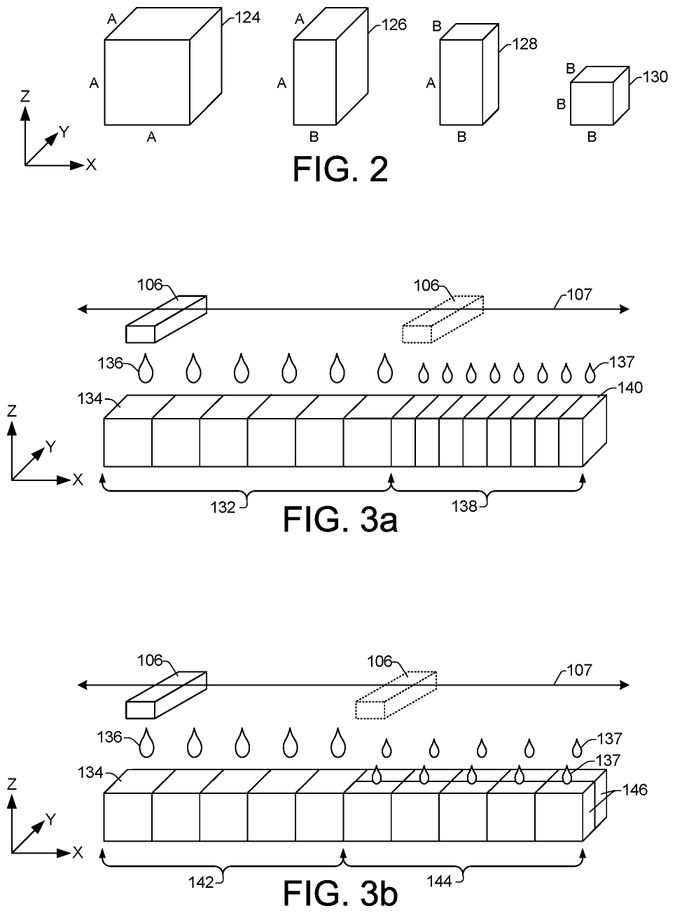

FIG. 2 shows examples of representative alterations that can be made to sizes of voxels of a 3D object model, and to the corresponding object voxels to be printed and fused to form a resultant 3D part. Voxel sizes can be altered within a 3D object model based on accompanying tolerance zone data that indicates variations in mechanical form tolerances throughout a part. Thus, while a 3D object model can define the form or physical dimensions of a 3D part to be printed, additional accompanying tolerance data can specify permissible limits in variation in the physical dimensions of the part. For example, a first zone or volume of a part may have a relaxed or “non-critical” tolerance assigned that permits a +/−200 um variation from form, while a second zone or volume of the part may have a tighter or more “critical” tolerance assigned that permits a +/−50 um variation from form. The sizes of voxels in a 3D object model can be altered to reflect these varying tolerances, and the corresponding object voxels can be printed and fused according to the altered voxels to generate a 3D part.

Thus, referring to FIG. 2, an example of a “nominal” voxel 124 that comprises an unaltered voxel size can be representative of a standard object voxel size that is to be printed on a print bed 102 (i.e., as an object voxel). An object voxel to be printed according to the nominal voxel 124 comprises a nominal layer thickness in the z-axis, and a nominal width and depth in the x-axis and y-axis, respectively, printed from a printhead 106 moving at a nominal speed in the x-axis and y-axis directions, for example. The nominal voxel 124 can be represented as a size “A” cube where the relative lengths of the voxel in each of the x-axis, y-axis, and z-axis are equal. An x-axis reduced voxel 126 shows that the relative x-axis dimension of the voxel can be reduced to size “B”, which can, in one example, be half the size of “A” for the purpose of illustration. In the reduced voxel 126, the y-axis and z-axis dimensions remain at size “A”. Thus, the altered size of the x-axis reduced voxel 126 can represent a smaller object voxel that is to be printed having a shortened width in the x-axis dimension. An x-axis/y-axis reduced voxel 128 shows that both the x-axis and y-axis dimensions of the voxel can be reduced to size “B”, while the z-axis dimension can remain at size “A”. Thus, the altered size of the x-axis/y-axis reduced voxel 128 can represent a smaller object voxel that is to be printed having a shortened width and depth in the x-axis and y-axis dimensions, respectively. A fully reduced voxel 130 shows that all of the x-axis, y-axis, and z-axis dimensions of the voxel can be reduced to size “B”, or half the size of “A”. Thus, the altered size of the fully reduced voxel 130 can represent a smaller object voxel (e.g., half-sized) that is to be printed having a shortened width, depth, and height (i.e., layer thickness) in the x-axis, y-axis, and z-axis dimensions, respectively.

To print object voxels that correspond with size altered voxels from a 3D object model, voxel dimensions along multiple and different axes of the 3D printing system can be manipulated to alter (e.g., reduce) corresponding dimensions of an object voxel along corresponding axes. Referring generally to FIGS. 1 and 2, object voxel dimensions in the x-axis can be governed by varying the distance of printhead movement or printhead motor stepping in the x-axis that occurs between each liquid droplet ejection for both scanning type and page-wide array type printheads 106. Object voxel dimensions in the y-axis dimension are generally governed by the nozzle pitch for page-wide array type printheads 106, but in some examples the y-axis dimension can also be adjusted through shifting the page-wide printhead in the y axis direction between two page-wide printhead passes. For scanning type printheads 106, object voxel dimensions in the y-axis dimension can be governed by the distance of printhead movement or printhead motor stepping in the y-axis. Variations in x-axis and possibly the y-axis dimensions can also include adjustments to the speed at which the printhead is moving. The printhead speed can be referred to as the printhead carriage velocity. Changes to the carriage velocity can also involve adjustments to the timing of liquid droplet ejections from the printhead. These timing adjustments can account for alterations in the velocities of the liquid droplets across the print bed during the flight time of the droplets in order to help provide accurate droplet placement and object voxel generation on the powder layer. In addition, these adjustments can include the use of alternate nozzle sized drop outlets and/or pulse-width-modulation to alter the volume of the liquid droplets to help control saturation of the powder within the powder layer.

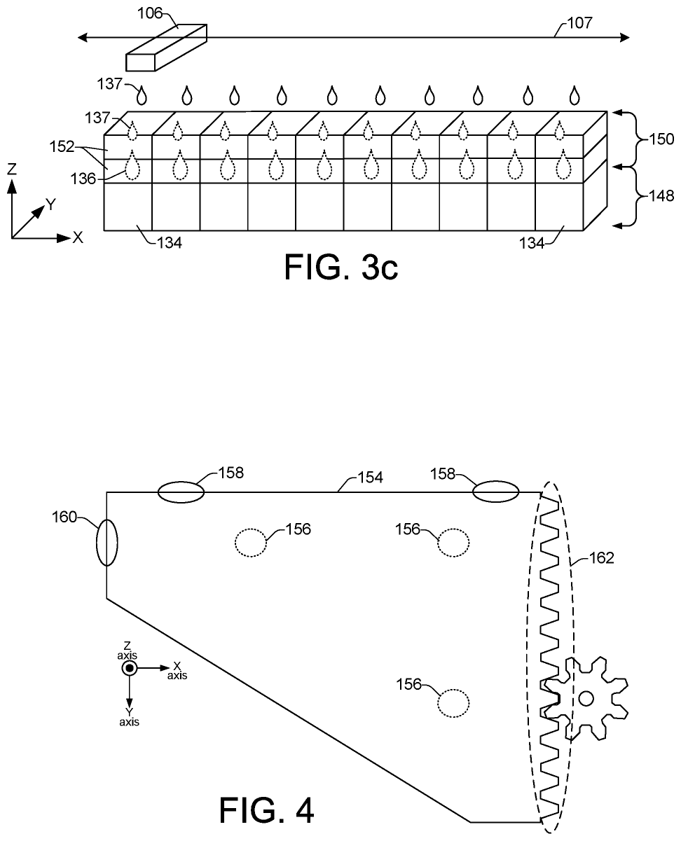

FIG. 3 (illustrated as FIGS. 3a, 3b, and 3c), shows example representations of how example object voxels can be printed in accordance with voxels of a 3D object model whose sizes have been altered within different tolerance zones. The examples help demonstrate how the size of object voxels being printed can be varied along any one, two, or three of the x-axis, y-axis, and z-axis dimensions in order to adjust the resolution of a 3D part within different tolerance zones of the part. While the examples in FIGS. 3a, 3b, and 3c, demonstrate variations in the size of object voxels along a single axis dimension at a time, in some examples such variations can also occur along multiple axis dimensions simultaneously to adjust the resolution of a 3D part along multiple axes.

Referring to FIG. 3a, a first tolerance zone 132 is shown with object voxels 134 being printed that correspond with voxels whose sizes have not been altered, such as nominal voxels 124 shown in FIG. 2. When printing in the first tolerance zone 132, the printhead 106 can move bi-directionally in the x-axis as indicated by direction arrow 107 while ejecting liquid droplets 136 onto a powder layer spread over the print bed 102. In the first tolerance zone 132, the printhead 106 ejects liquid droplets 136 in the x-axis dimension with a first spacing or distance between each droplet ejection. A second tolerance zone 138 is shown where x-axis reduced object voxels 140 are being printed corresponding with voxels of a 3D object model whose sizes have been shortened in the x-axis, such as the x-axis reduced voxel 126 shown in FIG. 2. When printing in the second tolerance zone 138, the printhead 106 ejects liquid droplets 137 in the x-axis dimension with a second spacing or distance between each droplet ejection. The second spacing is reduced, or shorter than the first spacing. Varying the spacing between droplet ejections can be achieved, for example, by adjusting the speed of movement of the printhead 106, and/or by adjusting the frequency of droplet ejection from the printhead. Adjusting the printhead speed and the ejection frequency can both be done “on-the-fly”, while the printhead traverses a layer of powder on the print bed 102. For example, as the printhead 106 transitions from the first tolerance zone 132 to the second tolerance zone 138, the speed of the printhead 106 can remain constant while the droplet ejection frequency can be increased to eject the liquid droplets 137 at a higher rate, thus reducing the space between ejected droplets 137. Alternatively, as the printhead 106 transitions from the first tolerance zone 132 to the second tolerance zone 138, the droplet ejection frequency can remain constant to eject the liquid droplets 137 at a constant rate, while the speed of the printhead 106 can be decreased, thus reducing the space between the ejected droplets 137. The reduced spacing between droplet ejections in the second tolerance zone 138 generates object voxels 140 that are shortened in the x-axis, which increases the resolution of the printed part along the x-axis within the second tolerance zone 138. As noted above, in addition to varying the distance or spacing of liquid droplets to control the size of printed object voxels between different tolerance zones, in some examples, the size or volume of liquid droplets can also be adjusted. In general, reduced volumes of liquid printed more frequently onto smaller object voxels (i.e., from reduced liquid droplet spacing) can help to prevent over saturation of the powder within the smaller object voxels, minimizing the spread of liquid between neighboring object voxels. As shown in FIG. 3a, for example, liquid droplets 136 ejected in the first tolerance zone 132 can be larger than liquid droplets 137 ejected in the second tolerance zone 138. Changes in droplet sizes/volumes can be implemented, for example, using printheads that have alternate nozzle sizes. Reducing the droplet size/volume in correspondence with reducing the spacing between the ejected droplets helps to maintain a more consistent level of liquid agent saturation within the printed part, which provides better fusing results. As discussed above with reference to FIGS. 1a, 1b, and 1c, 2D slice data from a 3D object model includes tolerance zone information that when rendered, provides 3D printing system commands that instruct the 3D printing system 100, for example, where (i.e., in which tolerance zones) and how (e.g., increasing droplet ejection frequency) to print x-axis reduced object voxels 140, where and how to print nominal object voxels 134, when to print with smaller or larger liquid droplets, and so on.

Referring now to FIG. 3b, a third tolerance zone 142 is shown with object voxels 134 being printed that correspond with voxels whose sizes have not been altered, such as nominal voxels 124 shown in FIG. 2. When printing in the third tolerance zone 142, the printhead 106 can move bi-directionally in the x-axis as indicated by direction arrow 107 while ejecting liquid droplets 136 onto a powder layer spread over the print bed 102. In the third tolerance zone 142, the printhead 106 ejects liquid droplets 136 in the x-axis dimension with a first spacing or distance between each droplet ejection. The liquid droplets 136 can be considered to have the same first spacing or distance in the y-axis dimension as well. The object voxels printed in the third tolerance zone 142 are not varied in size in either the x-axis or y-axis. A fourth tolerance zone 144 is shown where y-axis reduced object voxels 146 are being printed corresponding with voxels of a 3D object model whose sizes have been shortened in the y-axis, such as the y-axis reduced voxel 128 shown in FIG. 2. When printing in the fourth tolerance zone 144, the printhead 106 ejects liquid droplets 137 in the y-axis dimension with a second spacing or distance between each droplet ejection. The second spacing in the y-axis amounts to ejecting two liquid droplets within the same y-axis space as was used in the third tolerance zone 142 to eject one liquid droplet. The second spacing in the y-axis between the third zone 142 and fourth zone 144 has effectively been reduced, or is shorter than the first spacing. As noted above, the size or volume of liquid droplets can change between different tolerance zones (e.g., using printheads that have alternate nozzle sizes) to prevent over saturation of the powder within smaller object voxels, such as y-axis reduced object voxels 146. For example, as shown in FIG. 3b, liquid droplets 136 ejected in the third tolerance zone 142 can be larger than liquid droplets 137 ejected in the fourth tolerance zone 144. The different sized liquid droplets help to maintain a more consistent level of liquid agent saturation within the printed part which provides better fusing results. As discussed above with reference to FIGS. 1a, 1b, and 1c, 2D slice data from a 3D object model includes tolerance zone information that when rendered, provides 3D printing system commands that instruct the 3D printing system 100, for example, where (i.e., in which tolerance zones) and how (e.g., increasing droplet ejection frequency) to print y-axis reduced object voxels 146, where and how to print nominal object voxels 134, when to print with smaller or larger liquid droplets, and so on.

Referring to FIG. 3c, different tolerance zones are shown across layers of a part in the z-axis. Thus, a fifth tolerance zone 148 is shown with object voxels 134 having been printed in correspondence with voxels whose sizes have not been altered, such as nominal voxels 124 shown in FIG. 2. When printing in the fifth tolerance zone 148, the print bed 102 is moved in the z-axis with a first spacing or distance between layers to generate object voxels 134 when the printhead 106 ejects liquid droplets 136. Liquid drops 136 are shown with dotted lines to indicate that they have been deposited or ejected onto a previous powder layer to form the object voxels 134 within the fifth tolerance zone 148. A sixth tolerance zone 150 is shown where z-axis reduced object voxels 152 are being printed that correspond with voxels whose sizes have been shortened in the z-axis, such as the z-axis reduced voxel 130 shown in FIG. 2. When printing in the sixth tolerance zone 150, the print bed 102 is moved in the z-axis with a second spacing or distance between layers to generate object voxels 152 when the printhead 106 ejects liquid droplets 137. The reduced spacing of the powder layers provide thinner powder layers in the z-axis direction within the sixth tolerance zone 150 and generates object voxels 152 that are shortened in the z-axis. This increases the resolution of the printed part along the z-axis within the sixth tolerance zone 150. As noted above, the size or volume of liquid droplets can change between different tolerance zones (e.g., using printheads that have alternate nozzle sizes) to prevent over saturation of the powder within smaller object voxels, such as the object voxels 152 in tolerance zone 150. For example, as shown in FIG. 3c, liquid droplets 136 ejected in the fifth tolerance zone 148 can be larger than liquid droplets 137 ejected in the sixth tolerance zone 150. The different sized liquid droplets help to maintain a more consistent level of liquid agent saturation within the printed part which provides better fusing results. As discussed above with reference to FIGS. 1a, 1b, and 1c, 2D slice data from a 3D object model includes tolerance zone information that when rendered, provides 3D printing system commands that instruct the 3D printing system 100, for example, how far to move the print bed 102 in the z-axis to generate a particular powder layer thickness for increased or decreased z-axis part resolution, when to print with smaller or larger liquid droplets, and so on.

FIGS. 4, 5, and 6, show an example 3D part 154 that has a number of different tolerance zones throughout the part. The example part 154 is shown from a side view that enables illustration and discussion of the different tolerance zones within the part. The example part 154 comprises a “rack” 154 portion of a rack and pinion gear set. The pinion is shown merely to help illustrate the tolerance demands for printing the rack's form. The rack 154 is an example of a part that can have nonuniform tolerances throughout the part that can be specified and received, for example, within the information in a 3D object model, and/or within pre-processed 2D data slices derived from a 3D object model, such as discussed above with regard to FIGS. 1a, 1b, and 1c. For example, much of the rack 154 is present for structural reasons, and the bulk of its material may comprise non-critical surfaces that specify or comprise loose or relaxed mechanical tolerances. However, other regions or zones within the rack 154 may be more critical and may specify tighter mechanical tolerances in order to achieve a higher level of printing precision and greater part resolution. Therefore, an example 3D printing system 100 is enabled to print the more relaxed tolerance zones within the rack 154, while also printing the tighter tolerance zones with greater precision and increased resolution.

Referring now generally to the rack 154 shown in FIGS. 4-6, a number of datum features are shown with identified critical tolerance zone features for positioning the rack 154 during use. Such datum features, and other features, can be defined within a 3D object model, and/or 2D slice data from a 3D object model, along with the tolerance zone information as discussed above with regard to FIGS. 1a, 1b, and 1c. Thus, 2D slice data comprises tolerance zone information that can be rendered to instruct the 3D printing system when and how much to move a printhead in x-axis and y-axis directions for printing liquid droplets, as well as how far to move the print bed 102 in the z-axis direction to control the thickness of each layer of powder. There are three underside datums 156 that are located on the underside of the rack 154 that are illustrated by dotted line circles. The underside datums 156 can help to properly locate the rack 154 in the z-axis, for example. There are two side datums 158 located on the long side of the body of the rack 154 that are illustrated as solid line ovals. The side datums 158 can help to properly locate the rack 154 in the x-axis direction, for example. There is one end datum 160 located on the short end of the body of the rack 154, also illustrated as a solid line oval that can help to properly locate the rack 154 in the y-axis direction. In addition to the datums, another critical tolerance zone feature for the rack 154 includes the gear teeth 162. The gear teeth 162 are a critical tolerance zone feature because they come into contact with corresponding gear teeth of the pinion in order to produce the desired motion of the rack 154 during use.

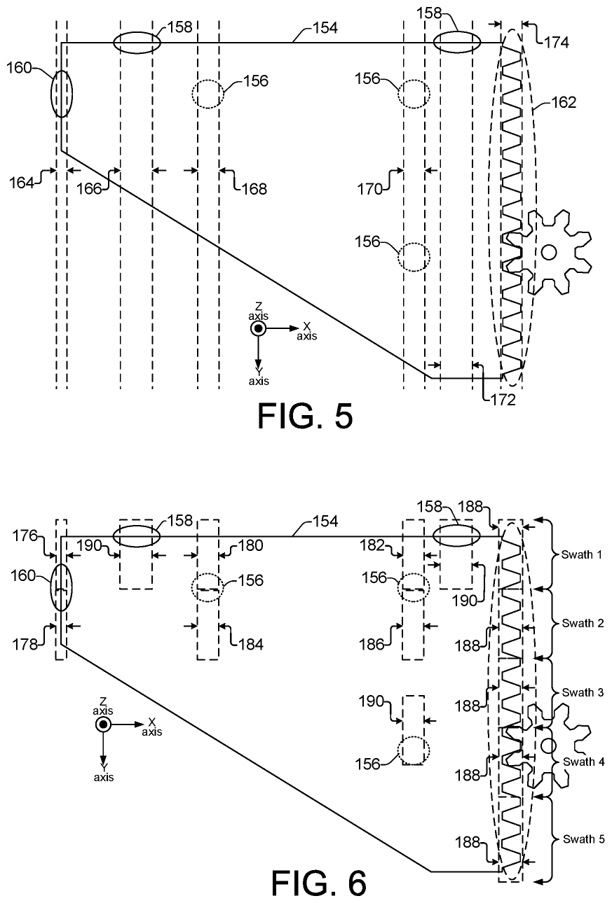

As shown in FIGS. 5 and 6, each of the critical tolerance features can be identified within a tolerance zone. FIG. 5 illustrates example tolerance zones for the rack 154 when the rack 154 is to be printed in a 3D printing system that implements a page-wide-array type printhead that spans the full y-axis dimension of the print bed as it moves back and forth in the x-axis while printing layers of the rack 154. Viewing FIG. 5 from left to right, critical tolerance zones that have been specified or identified as high resolution zones can include higher tolerance zone one 164 that covers the end datum 160 located on the short end of the body of the rack 154, higher tolerance zone two 166 that covers one of the side datums 158, higher tolerance zone three 168 that covers one of the underside datums 156, higher tolerance zone four 170 that covers the other underside datums 156, higher tolerance zone five 172 that covers the other side datum 158, and higher tolerance zone six 174 that covers the gear teeth 162. As generally discussed above with reference to FIGS. 1a, 1b, and 1c, tolerance zone data defining each tolerance zone can be specified and received, for example, within the information in a 3D object model or within pre-processed 2D data slices derived from a 3D object model. As discussed above with respect to FIG. 3, for example, object voxels within each tolerance zone can be printed in accordance with voxels of a 3D object model whose sizes have been altered in the x-axis, y-axis, and/or the z-axis.

FIG. 6 illustrates example higher tolerance zones for the rack 154 when the rack 154 is to be printed in 3D printing system that implements a scanning type printhead whose ejection nozzles span just a portion of the y-axis dimension of the print bed. A scanning type printhead can move back and forth in the x-axis while printing each swath of a layer of the rack 154. A scanning type printhead can also move in the y-axis to advance over each layer and print multiple swaths. Viewing FIG. 6 from left to right, critical tolerance features such as end datum 160, two of the underside datums 156, and the rack's gear teeth 162, can span across multiple print swaths. Thus, additional critical tolerance zones can be implemented that cover portions of different critical features. For example, a portion of the end datum 160 can be printed in higher tolerance zone one 176 within print Swath 1, and a portion can be printed in higher tolerance zone two 178 within print Swath 2. Similarly, portions of two underside datums 156 can be printed in higher tolerance zones three 180 and four 182 within print Swath 1, and portions of datums 156 can be printed in higher tolerance zones five 184 and six 186 within print Swath 2. The critical gear teeth 162 can be printed in five separate higher tolerance zones 188 that are spread across all of the print Swaths 1-5. The two side datums 158 and one of the underside datums 156 can be printed in different higher tolerance zones 190 that are each within a single print Swath.

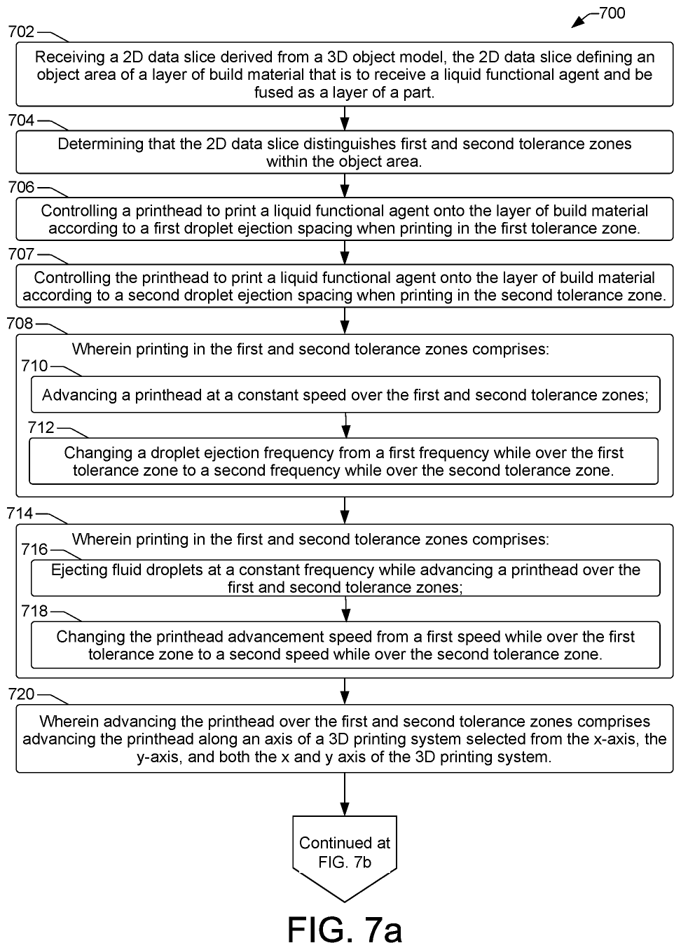

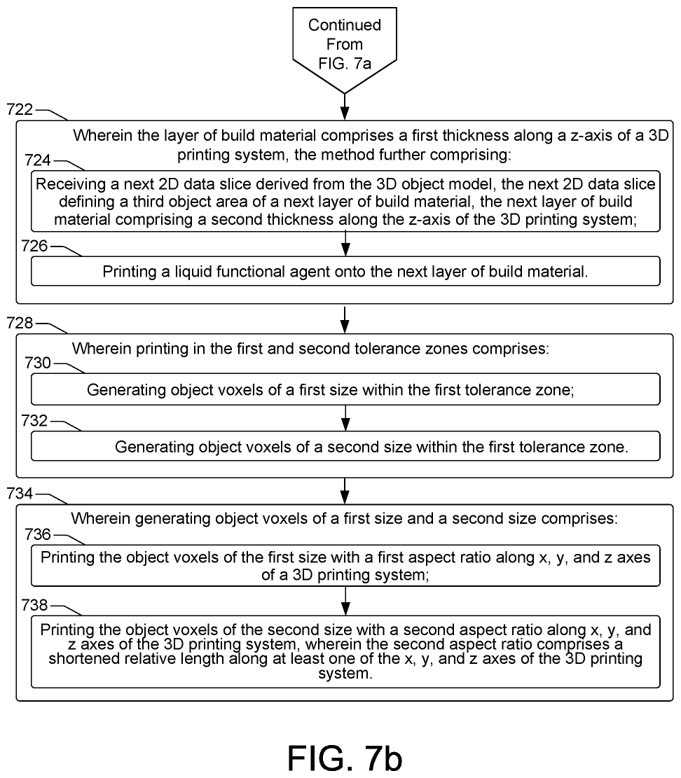

FIGS. 7 (7a, 7b) and 8 are flow diagrams showing example methods 700 and 800 of 3D printing. Methods 700 and 800 are associated with examples discussed above with regard to FIGS. 1-6, and details of the operations shown in methods 700 and 800 can be found in the related discussion of such examples. The operations of methods 700 and 800 may be embodied as programming instructions stored on a non-transitory, machine-readable (e.g., computer/processor-readable) medium, such as memory/storage 114 shown in FIG. 1. In some examples, implementing the operations of methods 700 and 800 can be achieved by a controller, such as a controller 110 of FIG. 1, reading and executing the programming instructions stored in a memory 114. In some examples, implementing the operations of methods 700 and 800 can be achieved using an ASIC and/or other hardware components alone or in combination with programming instructions executable by a controller 110.

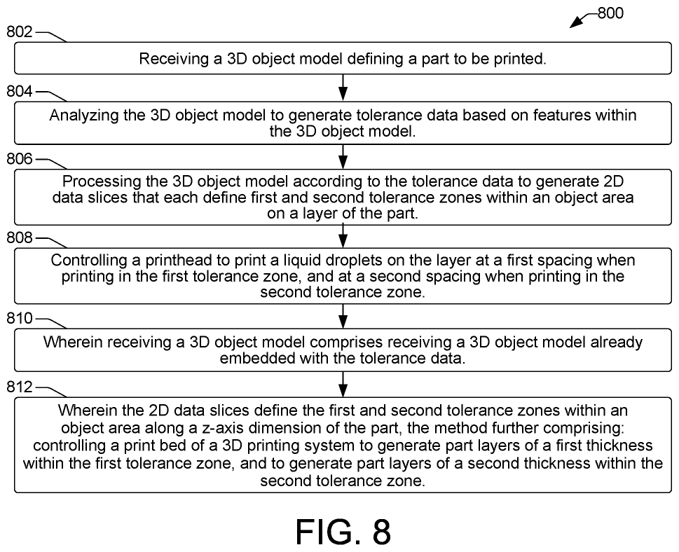

The methods 700 and 800 may include more than one implementation, and different implementations of methods 700 and 800 may not employ every operation presented in the respective flow diagrams of FIGS. 7 and 8. Therefore, while the operations of methods 700 and 800 are presented in a particular order within their respective flow diagrams, the order of their presentations is not intended to be a limitation as to the order in which the operations may actually be implemented, or as to whether all of the operations may be implemented. For example, one implementation of method 700 might be achieved through the performance of a number of initial operations, without performing other subsequent operations, while another implementation of method 700 might be achieved through the performance of all of the operations.

Referring now to the flow diagram of FIG. 7 (7a, 7b), an example method 700 of 3D printing begins at block 702 with receiving a 2D data slice derived from a 3D object model, where the 2D data slice defines an object area of a layer of build material to be printed. The method continues at block 704 with determining that the 2D data slice distinguishes first and second tolerance zones within the object area. As shown at blocks 706 and 707, respectively, the method includes controlling a printhead to print a liquid functional agent onto the layer of build material according to a first droplet ejection spacing when printing in the first tolerance zone, and controlling the printhead to print a liquid functional agent onto the layer of build material according to a second droplet ejection spacing when printing in the second tolerance zone. As shown at blocks 708, 710, and 712, printing in the first and second tolerance zones can include advancing a printhead at a constant speed over the first and second tolerance zones, and changing a droplet ejection frequency from a first frequency while over the first tolerance zone to a second frequency while over the second tolerance zone. In some examples, as shown at blocks 714, 716, and 718, printing in the first and second tolerance zones can include ejecting liquid droplets at a constant frequency while advancing a printhead over the first and second tolerance zones, and changing the printhead advancement speed from a first speed while over the first tolerance zone to a second speed while over the second tolerance zone. As shown at block 720, advancing the printhead over the first and second tolerance zones can include advancing the printhead along an axis of a 3D printing system selected from the x-axis, the y-axis, and both the x and y axis of the 3D printing system.

The method continues from FIG. 7a to FIG. 7b, at block 722, where the layer of build material can include a first thickness along a z-axis of a 3D printing system, and where the method can further include receiving a next 2D data slice derived from the 3D object model, the next 2D data slice defining a third object area of a next layer of build material, and the next layer of build material comprising a second thickness along the z-axis of the 3D printing system, as shown at block 724. As shown at block 726, the method can include printing a liquid functional agent onto the next layer of build material. In some examples, printing in the first and second tolerance zones can include generating object voxels of a first size within the first tolerance zone, and generating object voxels of a second size within the first tolerance zone, as shown at blocks 728, 730, and 732. In some examples, as shown at blocks 734, 736, and 738, generating object voxels of a first size and a second size can include printing the object voxels of the first size with first sizes along x, y, and z axes of a 3D printing system, and printing the object voxels of the second size with second sizes along x, y, and z axes of the 3D printing system, wherein the second size comprises a shortened length along at least one of the x, y, and z axes of the 3D printing system.

Referring now to the flow diagram of FIG. 8, an example method 800 of 3D printing begins at block 802 with receiving a 3D object model defining a part to be printed. The method includes analyzing the 3D object model to generate tolerance data based on features within the 3D object model, as shown at block 804. As shown at blocks 806 and 808, respectively, the method includes processing the 3D object model according to the tolerance data to generate 2D data slices that each define first and second tolerance zones within an object area on a layer of the part, and controlling a printhead to print liquid droplets on the layer at a first spacing when printing in the first tolerance zone, and at a second spacing when printing in the second tolerance zone. As shown at block 810, in some examples, receiving a 3D object model includes receiving a 3D object model already embedded with the tolerance data. In some examples, the 2D data slices define the first and second tolerance zones within an object area along a z-axis dimension of the part, as shown at block 812. In these examples, the method can further include controlling a print bed of a 3D printing system to generate part layers of a first thickness within the first tolerance zone, and to generate part layers of a second thickness within the second tolerance zone.

What is claimed is:

1. A method of three-dimensional (3D) printing comprising:
receiving a 2D data slice derived from a 3D object model, the 2D data slice defining an object area of a layer of build material that is to receive a liquid functional agent and be fused as a layer of a part;
determining that the 2D data slice distinguishes first and second tolerance zones within the object area;
controlling a printhead to print a liquid functional agent onto the layer of build material according to a first droplet ejection spacing when printing in the first tolerance zone; and,
controlling the printhead to print a liquid functional agent onto the layer of build material according to a second droplet ejection spacing when printing in the second tolerance zone.

2. A method as in claim 1, wherein printing in the first and second tolerance zones comprises:
advancing a printhead at a constant speed over the first and second tolerance zones; and,
changing a droplet ejection frequency from a first frequency while over the first tolerance zone to a second frequency while over the second tolerance zone.

3. A method as in claim 1, wherein printing in the first and second tolerance zones comprises:
ejecting liquid droplets at a constant frequency while advancing a printhead over the first and second tolerance zones; and,
changing the printhead advancement speed from a first speed while over the first tolerance zone to a second speed while over the second tolerance zone.

4. A method as in claim 1, wherein printing in the first and second tolerance zones comprises:
ejecting liquid droplets of a first size when printing in the first tolerance zone; and,
ejecting liquid droplets of a second size when printing in the second tolerance zone.

5. A method as in claim 2, wherein advancing the printhead over the first and second tolerance zones comprises advancing the printhead along an axis of a 3D printing system selected from the x-axis, the y-axis, and both the x and y axis of the 3D printing system.

6. A method as in claim 1, wherein the layer of build material comprises a first thickness along a z-axis of a 3D printing system, the method further comprising:
receiving a next 2D data slice derived from the 3D object model, the next 2D data slice defining a third object area of a next layer of build material, the next layer of build material comprising a second thickness along the z-axis of the 3D printing system; and,
printing a liquid functional agent onto the next layer of build material.

7. A method as in claim 1, wherein printing in the first and second tolerance zones comprises:
generating object voxels of a first size within the first tolerance zone; and,
generating object voxels of a second size within the second tolerance zone.

8. A method as in claim 7, wherein generating object voxels of a first size and a second size comprises:
printing the object voxels of the first size with a first length along x, y, and z axes of a 3D printing system; and,
printing the object voxels of the second size with a second length along x, y, and z axes of the 3D printing system, wherein the second length comprises a shortened length along at least one of the x, y, and z axes of the 3D printing system.

9. A 3D printing system comprising:
a memory to receive a 3D object model that represents a 3D part to be printed;
a processor programmed with 2D slice generator instructions to generate 2D data slices from the 3D object model, each 2D data slice to define an object area of a build material layer and to distinguish different tolerance zones within the object area; and,
a printhead to eject liquid droplets onto a build material layer according to a first droplet spacing when printing in a first tolerance zone, and to eject liquid droplets onto the build material layer according to a second droplet spacing when printing in a second tolerance zone.

10. A 3D printing system as in claim 9, wherein multiple 2D data slices define different z-axis tolerance zones by specifying different build material layer thicknesses, the system further comprising:
a print bed to generate layers of the 3D part according to the different build material layer thicknesses specified by the 2D data slices.

11. A 3D printing system as in claim 9, wherein the processor is programmed to generate tolerance zone data by analyzing features of the 3D object model, and to generate the 2D data slices based on the tolerance zone data and the 3D object model.

12. A 3D printing system as in claim 9, wherein the processor is programmed to generate tolerance zone data by receiving tolerance zone information input from a user, and to generate the 2D data slices based on the tolerance zone data and the 3D object model.

13. A method of 3D printing comprising:
receiving a 3D object model defining a part to be printed;
analyzing the 3D object model to generate tolerance data based on features within the 3D object model;
processing the 3D object model according to the tolerance data to generate 2D data slices that each define first and second tolerance zones within an object area on a layer of the part; and,
controlling a printhead to print liquid droplets on the layer at a first spacing when printing in the first tolerance zone, and at a second spacing when printing in the second tolerance zone.

14. A method as in claim 13, wherein receiving a 3D object model comprises receiving a 3D object model already embedded with the tolerance data.

15. A method as in claim 13, wherein the 2D data slices define the first and second tolerance zones within an object area along a z-axis dimension of the part, the method further comprising:
controlling a print bed of a 3D printing system to generate part layers of a first thickness within the first tolerance zone, and to generate part layers of a second thickness within the second tolerance zone.
